(19) United States
(12) Patent Application Publication
(10) Pub. No.: US 2009/0124485 A1
(43) Pub. Date: May 14, 2009

(54) CATALYTIC COMPOSITION COMPRISING CATALYTIC ACTIVATED CARBON AND CARBON NANOTUBES, MANUFACTURING PROCESS, ELECTRODE AND SUPER CAPACITATOR COMPRISING THE CATALYTIC COMPOUND

(76) Inventor: Dominique Plee, Lons (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/300,920

(22) PCT Filed: Apr. 27, 2007
(86) PCT No.: PCT/FR2007/000729

§ 371 Date: Nov. 14, 2008

Related U.S. Application Data
(60) Provisional application No. 60/819,859, filed on Jul. 11, 2006.

(30) Foreign Application Priority Data
May 16, 2006 (FR) 060345

(51) Int. Cl. H01M 4/88; B01J 31/06

(52) U.S. Cl. 502/101; 502/159; 977/742

(57) ABSTRACT

The subject of the invention is a composition comprising a polymer binder and a catalytic composite based on catalytic activated charcoal and carbon nanotubes. The catalytic composite comprises carbon nanotubes obtained by chemical vapour deposition of a hydrocarbon at a temperature ranging from 400 to 1100° C. on activated charcoal preimpregnated with a metal.

The subject of the invention is also the use of the composite as constituent material of electrodes intended especially for electrochemical double-layer energy storage cells (supercapacitors).

The invention also relates to the electrodes obtained and to the supercapacitors containing these composite materials, and also to the method of preparing electrodes based on the catalytic composite containing activated charcoal and carbon nanotubes on a collector.

The invention relates to a catalytic composition comprising a polymer binder and a catalytic composite based on catalytic activated charcoal and carbon nanotubes, and to the use of the composition as constituent material for electrodes intended especially for electrochemical double-layer energy storage cells (supercapacitors). The invention also relates to the electrodes obtained and to the supercapacitors containing these composite materials.

Storage cells called “supercapacitors” or EDLCs (Electric Double Layer Capacitors) consist of current collectors to which an activated substance comprising carbon materials is applied. This system is then immersed in a solvent containing a salt and allows electrical energy to be stored for subsequent use.

Energy storage cells must display a good compromise between energy density and power density, and also improved behaviour in respect of the internal resistance and/or a maintained capacitance for high current densities. Furthermore, these cells must exhibit good ageing properties.

The carbon materials supplied to collectors consist to a large part of charcoal. In recent years, electrodes based on a physical mixture of carbon nanotubes (CNTs) and activated charcoal (AC) have been developed. Thus, Liu et al. (Chinese Journal of Power Sources, Vol. 26, No. 1, 36, February 2002) have described such electrodes.

Tokin et al (JP 2000-124079 A) have described polarizable electrodes, consisting of a composition comprising charcoal, open-ended carbon nanotubes and binder, obtained by simple physical mixing of the constituents.

CN 1 388 540 discloses a composite consisting of carbon nanotubes and activated charcoal that are doped with transition metal oxides and with conductive polymers in order to obtain charge-accumulation EDLCs.

Recently, the Applicant in WO 2005/088657 A2 has described a method for manufacturing electrodes based on a mixture of activated charcoal and carbon nanotubes that also exhibit good ageing properties.

However, the Applicant has found that physical mixtures of carbon nanotubes, activated charcoal and binder result in the density of the electrode being lowered, to the detriment of the capacitance per unit volume or per unit mass.

With the present invention, the Applicant therefore proposes a catalytic composition comprising a polymer binder and carbon nanotubes obtained by chemical vapour deposition of a hydrocarbon, in particular ethylene, at a temperature ranging from 400 to 1100° C. on activated charcoal preimpregnated with a metal, the metal being selected from the transition metals Fe, Co, Ni and Mo, and preferably iron.

The catalytic composite mixed with a binder makes it possible to obtain a composition for coating electrodes, the properties of which are improved, in particular those relating to the conductivity, the capacitance per unit volume as a function of the current density, or else the ageing resistance.

According to one embodiment, the weight ratio of metal-impregnated activated charcoal to carbon nanotubes present in the catalytic composite ranges from 98/2 to 80/20.

According to one embodiment, the amount of impregnated metal on the activated charcoal is between IS and 15%, preferably between 1.5 and 10%.

According to a preferred embodiment, the activated charcoal has the following characteristics:

a) porosity:
microporous volume (diameter <2 nm) determined by the DFT method ranges from 0.5 cm³/g to 0.65 cm³/g and representing at least 75% and preferably at least 78% of the total porosity of said charcoal,
nitrogen BET specific surface area between 1000 and 1600 m²/g, preferably between 1200 and 1600 m/g;

b) purity:
pH between 5 and 8, preferably about 7, and total ash content, determined by the ASTM D2866-83 method, less than 1.5% by weight,
the percentage contents by weight of the following impurities, determined by mineralization (HNO₃/H₂O₂ treatment) followed by analysis by ICP emission spectrometry or, in the case of chlorides, by extraction with water followed by analysis by ion chromatography, are such that:
[chlorides]≦80 ppm
[chromium]≦20 ppm
[copper]≦50 ppm
[iron]≦300 ppm
[manganese]≦20 ppm
[nickel]≦10 ppm
[zinc]≦20 ppm

c) particle size distribution, determined by laser scattering, such that:

3 μm≦d₅₀≦15 μm

10 μm≦d₉₀≦60 μm; and

d) pH, determined by the CEFIC method, between 3.5 and 9, preferably between 4.5 and 8.

Preferably, the binder is selected from elastomers and thermoplastic polymers or blends thereof, preferably polyethers, polyalcohols, ethylene/vinyl acetate (EVA) copolymers, fluoropolymers and styrene/butadiene copolymers.

According to one embodiment, the binder is selected from polyoxyethylene (POE), polyoxypropylene (POP), polyvinyl alcohol (PVA), polytetrafluoroethylene (PTFE) and styrene/butadiene copolymers.

According to another embodiment, the binder is an aqueous suspension of PTFE or of a styrene/butadiene copolymer.

The proportion of binder ranges from 1% to 30% by weight relative to the amount of catalytic composite.

According to another subject, the invention relates to a method of preparing an electrode based on a catalytic composite containing activated charcoal and carbon nanotubes on a collector, comprising the following steps:
a. preparing a catalytic composite by a method comprising he following steps;
   i. the activated charcoal is mixed with a solution of a metal salt, preferably an aqueous solution comprising a nitrate or a sulphate;
   ii. the mixture is dried, the metal salt is then reduced and the activated charcoal impregnated with metal in metallic form is obtained; and
   iii. carbon nanotubes are synthesized on the activated charcoal obtained in step ii) by chemical vapour deposition (CVD) of a hydrocarbon at a temperature ranging from 400 to 1100° C.;
b. mixing of the catalytic composite with a solvent, preferably by ultrasonification;
c. addition of a polymer binder and mixing until homogenization;
d. drying of the paste;
e. optionally, kneading of the paste; and
f. coating and then drying of the collector.

According to a preferred mode, step b) is carried out at a temperature above 20° C., preferably in ethanol.

According to a preferred mode, step e) is carried out until fibrillation of the binder.

According to another subject, the invention relates to a method of preparing a paste based on a catalytic composite, comprising steps a) to e) described above.

According to yet another subject, the invention relates to an electrode with improved ageing, obtained by the method comprising steps a) to f) as described above.

According to yet another subject, the invention relates to an electrochemical supercapacitor comprising at least one electrode with improved ageing, as described above.

According to yet another subject, the invention relates to the use of a composition as described above in the form of a paste for coating electrode collectors.

The invention will now be described in greater detail in the description that follows.

The invention provides a composition comprising a binder and a catalytic composite comprising catalytic activated charcoal doped with carbon nanotubes. This catalytic composite is obtained by direct synthesis of carbon nanotubes on a catalytic activated charcoal. This composition, applied to a collector, makes it possible to obtain electrodes with improved ageing.

The invention also provides a method of preparing the composition and the electrodes comprising this composite.

The electrodes based on such catalytic materials have improved properties from the standpoint of conductivity, capacitance per unit volume as a function of the current density and/or ageing resistance. Likewise, the energy storage cells comprising these electrodes exhibit a very good compromise between energy density and power density.

The invention is also based on a method of preparing electrodes comprising collectors to which a carbon paste consisting of at least one catalytic composite is applied. The method of preparing the carbon paste comprises the following steps:

a) a catalytic composite comprising catalytic activated charcoal and carbon nanotubes is provided;

b) the catalytic composite in suspension in the solvent is mixed, in particular ultrasonically mixed for a time of between 5 and 60 minutes for example (at a temperature above 20° C., for example between 20 and 80° C.);

c) the binder is added until a homogeneous mixture is obtained;

d) a drying operation is carried out in order to evaporate the solvent

e) optionally, the paste is kneaded, in order to fibrillate the binder, especially when PTFE is used; and

f) the collectors are coated and then dried

Without prejudicing the correction operation of the method, steps b) and c) may be carried out at the same time. Step d) may also be carried out after step f), and in this case the solvent evaporation allows final drying of the electrodes.

This catalytic composite is prepared by direct growth of carbon nanotubes on an activated charcoal preimpregnated with a metal according to the following method:
i. activated charcoal is mixed with a solution of a metal salt;
ii. the mixture is dried, the metal salt is then reduced and activated charcoal impregnated with metal in metallic form, that is to say a metal in the zero valency state is obtained; and
iii. the carbon nanotubes are synthesized on the metal-impregnated activated charcoal by chemical vapour deposition (CVD) of a hydrocarbon at a temperature ranging from 400 to 1100° C.

Carbon nanotubes (CNTs) are also known and generally consist of one or more wound graphite sheets, i.e. SWNTs (single-walled nanotubes) or MWNTs (multi-walled nanotubes). These CNTs are commercially available or else may be prepared by known methods.

The activated charcoal used is of any type of charcoal conventionally used. Charcoals that may be mentioned include those obtained from lignocellulosic materials, (pine, coconut, etc.). Examples of activated charcoals that may be mentioned include those described in the application WO-A-02/43088 in the name of the Applicant. Any other type of activated charcoal is effective. The activated charcoal may be obtained by chemical activation or preferably by thermal or physical activation. The activated charcoal is preferably ground to a size, expressed as d₅₀, of less than about 30 microns and preferably to a d₅₀ of about 10 microns. The ash content of the charcoals is preferably less than 10%, advantageously less than 5%. These activated charcoals are commercially available or may be prepared by known methods.

Preferably, the charcoals selected have a micropore volume of greater than 0.35 cm³/g and a ratio of the micropore volume to the total pore volume of greater than 60%, these volumes being measured by N2 adsorption using the DFT method with slit pores, Preferably, the activated charcoals selected have the following characteristics:

a) porosity:
microporous volume (diameter <2 nm) determined by the DFT method ranging from 0.5 cm³/g to 0.65 cm³/g and representing at least 75% and preferably at least 78% of the total porosity of said carbon,
nitrogen BET specific surface area between 1000 and 1600 m²/g, preferably between 1200 and 1600 m²/g;

b) purity:
pH between 5 and 8, preferably about 7, and total ash content, determined by the ASTM D2866-83 method, less than 1.5% by weight,
the percentage contents by weight of the following impurities, determined by mineralization (HNO₃/H₂O₂ treatment) followed by analysis by JCP emission spectrometry or, in the case of chlorides, by extraction with water followed by analysis by ion chromatography, are such that:
   [chlorides]≦80 ppm
   [chromium]≦20 ppm
[copper]≦50 ppm
[iron]≦300 ppm
[manganese]≦20 ppm
[nickel]≦10 ppm
[zinc]≦20 ppm

c) particle size distribution, determined by laser scattering, such that

3 μm≦d₅₀≦15 μm

10 μm≦d₉₀≦60 μm; and

d) pH, determined by the CEFIC method, between 3.5 and 9, preferably between 4.5 and 8.

The activated charcoal is doped using a solution of a metal salt. The activated charcoal obtained is called a catalytic charcoal.

The metal used to dope the activated charcoal is a transition metal chosen from Fe, Co, Ni and Mo, and is preferably iron.

The metal used may be in any oxidized form, whether or not hydrated, preferably in the form of an oxide, hydroxide, nitrate or sulphate.

In general, the metal salt is dissolved in a solvent, which may be water, and it is mixed with the activated charcoal so as to obtain the metal-salt-impregnated activated charcoal. Advantageously, aqueous solutions of iron nitrates or sulphates, preferably hydrated, are used.

The amount of impregnated metal on the activated charcoal is between 1.5 and 15%, preferably between 1.5 and 10%, by weight relative to the amount of activated charcoal introduced.

Next, the operation of drying the mixture is carried out. This drying operation is generally carried out at a sufficient temperature and for a sufficient time to obtain a handleable state of the mixture.

The metal salt, preferably the iron salt, impregnating the activated charcoal with salt is then raised in temperature in nitrogen for example up to 300° C. when iron is used as metal. This temperature rise has the effect of decomposing the iron salt, before its reduction to metal in the zero valency state.

The reduction step is then generally carried out in a hydrogen atmosphere at a temperature that may be up to 800° C., preferably up to 650° C., for a time needed to result in the reduction of the metal salt preferably for 10 to 30 minutes. These temperature and time parameters are readily defined by a person skilled in the art and easily adaptable to a different metal salt.

The carbon nanotubes are then synthesized on the metal-impregnated activated charcoal thus obtained, by chemical vapour deposition (CVD) of a hydrocarbon at a temperature ranging from 400 to 1100° C., preferably 300° C. The hydrocarbon used is preferably ethylene.

The amount of CNT synthesized on the catalytic activated charcoal ranges from 1 to 50%, preferably 2 to 20%. This amount depends on the time devoted to the CVD. Thus, the catalytic composite has a catalytic activated charcoal or metal-impregnated activated charcoal/CNT weight ratio that ranges from 99/1 to 50/50, preferably from 98/2 to 80/20.

Thus, with the method according to the invention, what is obtained is a catalytic composite the pores of the active charcoal of which have not been saturated with CNTs, which composite therefore contains a small amount of carbon nanotubes.

This catalytic composite makes it possible, as explained below, to prepare a carbon paste that is applied to electrode collectors, the electrodes of which consequently have improved properties. The method of preparing the carbon paste comprises the above mentioned steps b) to D.

In step b), the catalytic composite is mixed with a solvent. The solvent used may be any aqueous or organic solvent compatible with the raw materials to be dispersed, such as acetonitrile or ethanol. This solvent, which is used to adjust the plasticity of the paste, is preferably an evaporable solvent.

The amount of binder introduced in step c) represents from 1 to 30%, preferably 2 to 10%, by weight relative to the amount of catalytic composite present. Thus, the carbon paste obtained after homogenizing and drying the polymer binder/catalytic composite mixture contains a catalytic composite/polymer binder weight ratio that ranges from 99/1 to 70/30, preferably from 98/2 to 90/10.

The polymers used as polymer binder may for example be elastomers or thermoplastic polymers or blends thereof that are soluble in said solvent. Among these polymers, polyethers, such as polyoxyethylene (POE), polyoxypropylene (POP) and/or polyalcohols, such as polyvinyl alcohol (PVA), ethylene/vinyl acetate (EVA) copolymers, fluoropolymers, such as polytetrafluoroethylene (PTFE), and styrene/butadiene (SB) copolymers may in particular be mentioned. It is advantageous to use binders in aqueous suspension.

The invention also relates to the carbon paste, obtained by the method according to the invention, intended for coating electrode collectors.

The catalytic composite comprising carbon nanotubes obtained by chemical vapour deposition of a hydrocarbon at a temperature ranging from 400 to 1100° C. on an activated charcoal preimpregnated with a metal may be considered as an intermediate product for obtaining the carbon paste according to the invention.

The invention also relates to the electrodes manufactured using the above method.

In the manufacture of such electrodes, it is possible to use other constituents and third bodies, such as carbon blacks.

These electrodes are useful for the manufacture of electrochemical double-layer energy storage cells (EDLC supercapacitors).

An EDLC-type supercapacitor is composed of: a pair of electrodes (1), one (and preferably both) of which is an electrode with a carbon paste according to the invention; a porous ion-conducting separator (2) comprising an electrolyte; and a non-ionically conducting collector (3) for making electrical contact with the electrodes.

Manufacture of the electrodes (1), starts with the paste or slurry obtained as described above, which will be applied to a support and the solvent then evaporated in order to form a film. Next, the paste obtained is applied to a support, especially by coating. It is advantageous for the coating to be carried out on a peelable support, for example using a template, generally of flat shape.

Next, the solvent is evaporated, for example under a hood. What is obtained is a film whose thickness depends especially on the charcoal paste concentration and on the deposition parameters, the thickness generally being between a few microns and 1 millimetre. For example, the thickness is between 100 and 500 microns.

Suitable electrolytes to be used for producing EDLC supercapacitors consist of any highly ionically conducting medium, such as an aqueous solution of an acid, a salt or a base. If desired, non aqueous electrolytes may also be used, such as tetraethyl ammonium tetrafluoroborate (Et₄NBF₄) in acetonitrile, or γ-butyrolactone or propylene carbonate.

One of the electrodes may be composed of another material known in the art.

Between the electrodes is a separator (2) generally made of a highly porous material, the functions of which are to ensure electronic isolation between the electrodes (1), whilst still allowing ions to pass through the electrolyte. In general, any conventional separator may be used in an EDLC supercapacitor of high power density and energy density. The separator (2) may be an ion-permeable membrane that allows ions to pass through it but prevents electrons from passing through it.

The ion-impermeable current collector (3) may be any electrically conducting material that is not an ion conductor. Satisfactory materials to be used to produce these collectors comprise: charcoal, metals in general, such as aluminium, conducting polymers, non-conducting polymers filled with a conducting material so as to make the polymer electrically conducting, and similar materials. The collector (3) is electrically connected to an electrode (1).

The manufacturing method and the energy storage cell according to the invention will be described in greater detail in the following examples. These examples are provided by way of illustration but imply no limitation of the invention.

### EXAMPLES

### Preparation of the Storage Cells/Measurement

In the examples, the electrodes were manufactured as follows:
ultrasonic mixing of 95% of a charcoal/nanotube catalytic composite, in suspension in 70% ethanol, for 15 minutes followed by addition of 5% PTFE as a 60 wt % aqueous suspension;
evaporation and kneading of the paste in the presence of ethanol until complete fibrillation of the PTFE;
drying of the paste at 100° C., and
coating of the 100 to 500 microns thick aluminium collectors with the paste in order to form the electrode. The collectors are made of 99.9% aluminium and the total thickness, after lamination, was 350 to 450 microns.
   The catalytic composite was obtained by directly synthesizing nanotubes on the surface of the activated charcoal into which a metal had been deposited beforehand.

The cells were assembled in a glove box in an atmosphere having a controlled content of water and oxygen, the contents being less than 1 ppm. Two square electrodes 4 cm² in area were taken and a separator made of a microporous polymer inserted between them. The whole element was held in place with two PTFE shims and two stainless steel clips and then placed in an electrochemical cell containing the electrolyte (an acetonitrile/tetraethyl ammonium tetrafluoroborate mixture).

In the examples, the electrochemical measurement protocol was the following:
galvanostatic cycling: a constant current of +20 mA or −20 mA was imposed at the terminals of the capacitor and a charge-discharge curve generated: the variation in the voltage was monitored as a function of time between 0 and 2.3 V. The capacitance was deduced from the discharge slope of the capacitor, the capacitance being expressed per electrode and per gram of active material, by multiplying this value by two and by dividing by the mass of active material. The resistance was measured by impedance spectroscopy. This test consisted in subjecting the capacitor to a low-amplitude sinusoidal voltage of variable frequency around an operating point (Vₛ=0; Iₛ=0). The response current was out of phase with the excitation voltage. The complex impedance was therefore the ratio of the voltage to the current, similar to a resistance. The resistance was expressed as the real part of the impedance, for a frequency of 1 kHz multiplied by the area of the electrode; and
ageing tests carried out in the following manner: ±100 mA/cm² galvanostatic cycling was carried out between 0 and 2.3 volts. The capacitance was deduced directly from the discharge line of the supercapacitor and the resistance was measured at each end of charging by a series of 1 kHz current pulses. The measurements taken at each cycle are used to monitor the variation in the capacitance and the resistance of the supercapacitor as a function of the number of charge/discharge cycles. The cycling was carried out for as many cycles as needed to estimate the ageing.

### Example 1

### Control

The activated charcoal used was that called “Acticarbone” sold by the company CECA.

The charcoal tested had a d₅₀ particle size, estimated by laser scattering, of around 8 microns and was subjected to an additional treatment in a liquid phase for lowing the ash content. Its pH was about 6.5.

The BET surface area and the pore volumes, determined by the DFT (slit pore) method were as indicated below;
specific surface area=1078 m²/g;
micropore (<2 nm) volume=0.5 cm³/g;
mesopore (2-50 nm) volume=0.15 cm³/g; and
macropore (>50 nm) volume=0.1 cm³/g.

9.5 g of this charcoal were mixed in 100 ml of water with 0.5 g of MWNT carbon nanotubes sold by Arkema, the mixture being ultrasonically treated for 10 minutes, and the resulting paste was dried at 110° C.

The characteristics of these nanotubes were:
specific surface area=220 m²/g;
Fe=1.7%;
Al=2.2%; and
d₅₀ (Malvern)=40 microns.

The properties of this physical charcoal/carbon nanotube mixture are given in Table I.

### Example 2

### Catalytic Activated Charcoal 1

The catalytic activated charcoal on which carbon nanotubes were to be synthesized was prepared by impregnating 100 g of Acticarbone charcoal by means of 80 ml of an iron nitrate nonahydrate solution so as to deposit 2.5 wt % iron into the activated charcoal. The deposition was carried out over 10 minutes at room temperature. This specimen was called catalytic activated charcoal I.

### Catalytic Activated Charcoal 2

The operation was repeated by depositing 5 wt % iron using an equivalent method. This specimen was called catalytic activated charcoal 2.

After deposition, the impregnated charcoals were dried at 80° C. and then introduced into a vertical reactor 25 cm in diameter and 1 m in height, in which they were heated in nitrogen up to 300° C.

This temperature was maintained for the purpose of decomposing the iron salt, but another temperature suitable for a different salt would not be outside the scope of the invention.

The nitrogen flow rates were selected so as to ensure slight fluidization, for example 2 to 4 Sl/h. Next, a quarter of the nitrogen gas flows was replaced with hydrogen in order to reduce the iron salt, the temperature was raised to 650° C., where it remained for 20 minutes. At that moment, the nitrogen was replaced with ethylene in order to initiate the growth of carbon nanotubes on the catalytic activated charcoal.

The following trials were carried out:

### Trial 1: Composite 1 (C1)

Catalytic activated charcoal: 1 and 15 minutes of carbon nanotube synthesis.

The weight increase of the recovered material, corresponding to the amount of CNT grown on the catalytic activated charcoal, was about 6%.

### Trial 2; Composite 2 (C2)

Catalytic activated charcoal: 1 and 45 minutes of carbon nanotube synthesis.

The weight increase of the recovered material, corresponding to the amount of CNT grown on the catalytic activated charcoal, was about 13%.

### Trial 3: Composite 3 (C3)

Catalytic activated charcoal: 1 and 15 minutes of carbon nanotube synthesis.

The weight increase of the recovered material, corresponding to the amount of CNT grown on the catalytic activated charcoal, was about 5%.

### Example 3

The electrochemical assembly described above was prepared from composite I and the performance measured.

### Example 4

The electrochemical assembly described above was prepared from composite 2 and the performance measured.

### Example 5

The electrochemical assembly described above was prepared from composite 3 and the performance measured.

The results are given in Table I below:

TABLE I

| | | | Capacitance per unit weight | | Resistance at 1 kHz | |
|---|---|---|---|---|---|---|
| | Density of the electrodes | | at 5 mA/cm² (F/g) | | (ohms · cm²) | |
| | Initial | After ageing | Initial | After ageing | Initial | After ageing |
| Ex. 1 | 0.47 | 0.47 | 43 | 39 | 0.67 | 0.79 |
| AC/CNT | | | | | | |
| Ex. 3 | 0.57 | 0.57 | 50 | 46 | 0.65 | 0.75 |
| C1/6% CNT | | | | | | |
| Ex. 4 | 0.55 | 0.54 | 46 | 42 | 0.63 | 0.73 |
| C2/13% CNT | | | | | | |
| Ex. 5 | 0.59 | 0.58 | 52 | 47 | 0.67 | 0.79 |
| C3/5% CNT | | | | | | |

This shows that the method proposed by the invention makes it possible to increase the density of the electrodes over that of the prior art. This increase in their density correspondingly increases their capacitance per unit weight, while maintaining their resistance.

In addition, the ageing tests show that the method proposed by the invention makes it possible to maintain the density of the electrode and consequently to retain their capacitance per unit weight, while still maintaining the other performance characteristics such as the resistance. This means that the energy density of the system according to the invention is maintained at least as well as, if not better than, that of the prior art.

1. Catalytic composition comprising a polymer binder and carbon nanotubes obtained by chemical vapour deposition of a hydrocarbon at a temperature ranging from 400 to 1100° C. on activated charcoal preimpregnated with a metal.

2. Composition according to claim 1, in which the hydrocarbon is ethylene.

3. Composition according to claim 1, in which the metal is selected from the transition metals Fe, Co, Ni and Mo, preferably iron.

4. Composition according to claim 1, in which the weight ratio of metal-impregnated activated charcoal to carbon nanotubes present in the catalytic composite ranges from 98/2 to 80/20.

5. Composition according to claim 1, in which the amount of impregnated metal on the activated charcoal is between 1.5 and 15%, preferably between 1.5 and 10%.

6. Composition according to claim 1, in which the activated charcoal has the following characteristics:
a) porosity:
microporous volume (diameter <2 nm) determined by the DFT method ranges from 0.5 cm³/g to 0.65 cm³/g and representing at least 75% and preferably at least 78% of the total porosity of said charcoal,
nitrogen BET specific surface area between 1000 and 1600 m²/g, preferably between 1200 and 1600 m²/g;
b) purity:
pH between 5 and 8, preferably about 7, and total ash content, determined by the ASTM D2866-83 method, less than 1.5% by weight,
the percentage contents by weight of the following impurities, determined by mineralization (HNO₃/H₂O₂ treatment) followed by analysis by ICP emission spectrometry or, in the case of chlorides, by extraction with water followed by analysis by ion chromatography, are such that:
[chlorides]≦80 ppm
[chromium]≦20 ppm
[copper]≦50 ppm
[iron]≦300 ppm
[manganese]≦20 ppm
[nickel]≦10 ppm
[zinc]≦20 ppm
c) particle size distribution, determined by laser scattering, such that:
3 μm≦d₅₀≦15 μm
10 μm≦d₉₀≦60 μm; and
d) pH, determined by the CEFIC method, between 3.5 and 9, preferably between 4.5 and 8.

7. Composition according to claim 1, in which the binder is selected from elastomers and thermoplastic polymers or blends thereof, preferably polyethers, polyalcohols, ethylene/vinyl acetate (EVA) copolymers, fluoropolymers and styrene/butadiene copolymers.

8. Composition according to claim 1, in which the binder is selected from polyoxyethylene (POE), polyoxypropylene (POP), polyvinyl alcohol (PVA), polytetrafluoroethylene (PTFE) and styrene/butadiene copolymers.

9. Composition according to claim 1 in which the binder is an aqueous suspension of PTFE or of a styrene/butadiene copolymer.

10. Composition according to claim 1, in which the proportion of binder ranges from 1% to 30% by weight relative to the amount of catalytic composite.

11. Method of preparing an electrode based on a catalytic composite containing activated charcoal and carbon nanotubes on a collector, comprising the following steps:
a. preparing a catalytic composite by a method comprising the following steps;
i. the activated charcoal is mixed with a solution of a metal salt;
ii. the mixture is dried, the metal salt is then reduced and the activated charcoal impregnated with metal in metallic form is obtained; and
iii. carbon nanotubes are synthesized on the activated charcoal obtained in step ii) by chemical vapour deposition (CVD) of a hydrocarbon at a temperature ranging from 400 to 1100° C.
b. mixing of the catalytic composite with a solvent;
c. addition of a polymer binder and mixing until homogenization;
d. drying of the paste;
e. optionally, kneading of the paste; and
f. coating and then drying of the collector.

12. Method according to claim 11, in which the metal salt solution is an aqueous solution comprising a nitrate or a sulphate.

13. Method according to claim 1, in which step b) is carried out by ultrasonification.

14. Method according to claim 11, in which step b) is carried out at a temperature above 20° C.

15. Method according to claim 11, in which step e) is carried out until fibrillation of the binder.

16. Method according to claim 11, in which the solvent of step b) is ethanol.

17. Method of preparing a paste based on a catalytic composite, comprising the steps
a. preparing a catalytic composite by a method recited in steps i to iii of claim 11
b. mixing of the catalytic composite with a solvent;
c. addition of a polymer binder and mixing until homogenization;
d. drying of the paste;
e. optionally, kneading of the paste.

18. Method according to claim 17, wherein the activated charcoal has the following characteristics a), b), c), and d) of claim 6.

19. Electrode with improved ageing, obtained by the method according to claim 11.

20. Electrochemical supercapacitor comprising at least one electrode according to claim 19.

21. A method of using a composition according to claim 1 in the form of paste which comprises coating electrode collectors with said composition.
